(19) United States
(12) Patent Application Publication
(10) Pub. No.: US 2006/0250662 A1
(43) Pub. Date: Nov. 9, 2006

(54) Apparatus for increasing efficiency in the workplace through improved scanning and disposing of documents

(75) Inventor: Warren S. Heit, Los Altos Hills, CA (US)

Correspondence Address: VIERRA MAGEN MARCUS & DENIRO LLP, 575 MARKET STREET SUITE 2500, SAN FRANCISCO, CA, 94105, US

(73) Assignee: Tinkers & Chance

(21) Appl. No.: 11/123,645

(22) Filed: May 5, 2005

(51) Int. Cl. H04N 1/04

(52) U.S. Cl. 358/474; 358/498; 358/1.15

(57) ABSTRACT

A document scanner is provided which is adapted to be positioned above the opening of a garbage can or recycle bin. The scanner comprises a collar that is configured to mate with the upper rim of a garbage can or recycle bin. The scanner includes a paper feeder that feeds the document past a scanning element and into the can or bin. The scanner is linked to a computer or computer network. An application running on the computer or network receiving data from the scanner to convert the hardcopy document into an electronic or softcopy which can be easily stored in a computer database. The scanned documents pass through the scanner and land in the garbage can or recycle bin.

### FIELD OF THE INVENTION

This invention relates generally to an apparatus designed to increase worker efficiency in the workplace. More particularly, the present invention is directed to an improved apparatus for scanning and disposing of documents while converting them from hardcopy to electronic format.

### BACKGROUND

The “paperless” office has long been the holy grail of the information technology revolution. Every year, significant progress is made. Recently, with the advent and widespread use of email and wireless communication with devices such as Blackberrys and PDAs, the paperless office is becoming more of a reality.

While great progress has been made toward the paperless office, documents in hardcopy (in other words, documents on paper) remain very much a part of every day life. Almost all entities (government, corporations, phone companies, utilities, banks, other financial instructions, law firms, non-profit agencies, etc.) utilize and rely upon arcane vestiges of the last century—printers, facsimiles, letters or other correspondence sent via mail or overnight courier (such as FedEx)—to generate documents in hardcopy. These hardcopy documents play an important role in society—they are bills, bank statements, letters, photographs—that communicate important and often personal information. Hardcopy documents take up a significant amount of desk and storage space, are a potential security risk if not disposed of correctly and are not as easy to organize and file as their electronic softcopy counterparts.

Scanners are a very important part of office and home life. Scanners convert hardcopy documents (bills, photographs, letters, faxes, etc.) into softcopy documents that can be neatly stored on computer storage mediums. Scanners usually come in one of two forms. Many scanners come integrated into another piece of office or home information technology equipment such a copier or fax machine. These are commonly referred to as “all-in-one” scanners. Alternatively, scanners can be standalone—separate items of office or home information technology equipment. Usually standalone scanners rely upon flatbeds to scan documents. These standalone scanners typically take up a significant amount of desk space making it inconvenient to have in one's individual office or room. Moreover, standalone scanners have been relatively expensive and fragile devices, and have been placed in protected, out-of-the-way locations to ensure they are not damaged. Other scanners, such as hand held or bar code scanners are not well adapted to handle the high scanning volume necessary to make an office paperless.

U.S. Pat. No. 6,779,747 titled “Intelligent Document Shredder Device” and U.S. patent application Ser. No. 09/995,476 of the same title (a continuation-part of U.S. Pat. No. 6,779,747) discloses a method of using a scanner to determine a desired cut pattern for intelligently shredding a document to render the information on the document unintelligible and prevent or minimize reassembly of the shredded document to reconstruct the information contained in the document.

Thus, there is a need for a scanner that is designed to be use by an individual in his/her office that does not occupy desk space yet is readily available and accessible to allow the user to covert hardcopy document into softcopy and to dispose of the originals efficiently and securely.

### SUMMARY

It is an advantage of the present invention to increase the efficiency in the workplace by making a scanner a part of standard office/home equipment in every office/room of an organization/home.

It is a further advantage of the present invention to make a scanner readily available and accessible to facilitate the process of transforming to a paperless office/home.

It is another advantage of the present invention to reduce or even eliminate the amount of desk space a standalone scanner would occupy.

These and other advantages of the present invention are achieved by the present invention. In accordance with one embodiment, a document scanner is provided which is adapted to be positioned above the opening of a garbage can or recycle bin. The scanner comprises a collar that is configured to mate with the upper rim of a garbage can or recycle bin. The scanner includes a paper feeder that feeds the document past a scanning element and into the can or bin. The scanner is linked to a computer or computer network. An application running on the computer or network receives data from the scanner to convert the hardcopy document into an electronic or softcopy which can be easily stored in a computer database. The scanned documents pass through the scanner and land in the garbage can or recycle bin.

In accordance with other aspects of the present invention, a stand instead of a collar supports the scanner above or adjacent the opening of the garbage can. The stand can also support a shredder which shreds the documents after they are scanned by the scanner.

For purposes of summarizing the present mounting arrangement and the advantages achieved over the prior art, certain advantages have been described herein above. Of course, it is to be understood that not necessarily all such advantages may be achieved in accordance with any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention. These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is an illustration of an scanner having features in accordance with an embodiment of the present invention;

FIG. 2 is a front and perspective view of a scanner having features in accordance with an embodiment of the present invention;

FIG. 2A is a cross-section of a scanner with a holding cell in accordance with an embodiment of the present invention;

FIG. 2B is a top view of a scanner in accordance with a configuration in accordance with an embodiment of the present invention;

FIG. 3 is a side view and front view of a scanner and support stand having features in accordance with an embodiment of the present invention;

FIG. 3A is a side view of a scanner and support stand having features in accordance with an embodiment of the present invention;

FIG. 4 is a side view and a front view of a scanner and shredder having features in accordance with an embodiment of the present invention; and

FIG. 5 is a top view of various scanner and shredder configurations having features in accordance with an embodiment of the present invention.

### DETAILED DESCRIPTION OF THE DRAWINGS

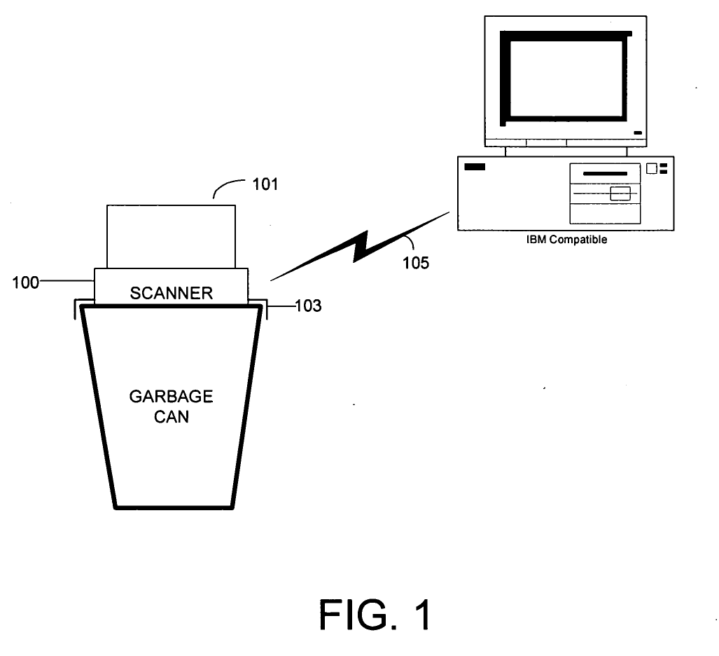

The present invention will now be described with reference to FIGS. 1-5 which in embodiments relate to a scanner which is adapted to be positioned above the opening of a garbage can or recycle bin. It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

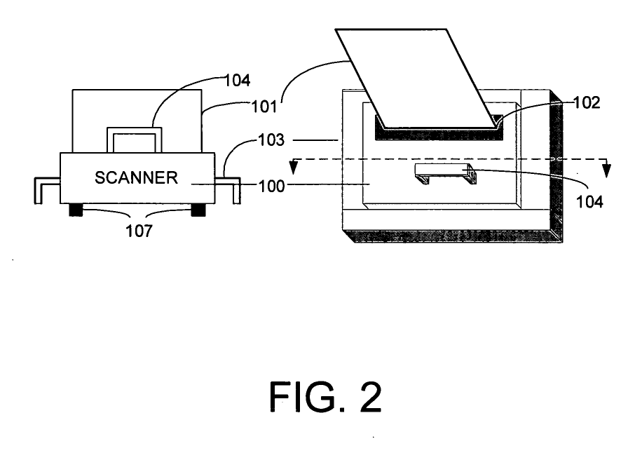

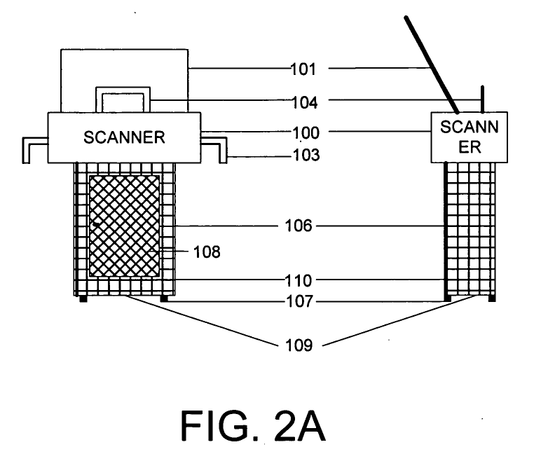

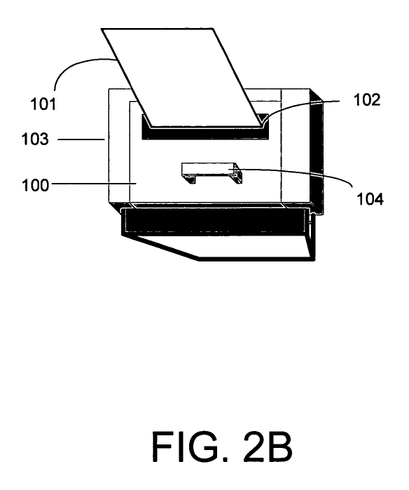

FIGS. 1-2A are illustrations of a scanner according to a preferred embodiment of the present invention. Scanner 100 includes document input tray 101, document entry slot 102, document handling mechanism (not shown), scanning element (not shown), document egress slot (not shown), collar 103, handle 104 and communication link 105. The scanner includes various a control panel and/or buttons which control the operation of the scanner. The control panel and/or buttons are accessible to the user of the scanner.

As shown in FIGS. 1-2B, document input tray 101 is a substantially planar element to hold documents on scanner 100. Document input tray 101 is maintained at an appropriate angle relative to horizontal to facilitate feeding of documents into scanner 100. The document handling mechanism grabs the documents one page at a time from the document input tray 101 and pulls them into the document entry slot 102. The document handling mechanism feeds each page past the scanning element. The scanning element scans each page as it passes the scanning element. The document handling mechanism passes each page through the document egress slot on the bottom of the scanner until the page is released into the garbage can/recycle bin. In an alternative embodiment described below, each page is released into a holding cell 106 until it is later released by the user into the garbage can/recycle bin.

The collar 103 exists about the periphery of the housing of the scanner. The collar 103 may be formed as an integral part of the housing of the scanner. Because of the use of molded plastics, forming the collar 103 as part of the housing improves the manufacturability of the device. Alternatively, the collar 103 may be affixed to the housing. In an alternative embodiment discussed below, the collar 103 may be removed from the housing to convert the scanner into a portable device. The size and shape of collar 103 are chosen to allow it to mate with the upper rim of garbage can or recycle bins in wide use. As illustrated in FIGS. 1-2B, collar 103 has attachment flanges resting atop and flowing over the edge of the upper rim of receptacle to support and generally prevent the scanner from moving laterally. The upper rim of most garbage cans and recycle bins are generally rectangular shape with rounded corners. Thus, to mate with those receptacles, collar 103 would have a rectangular shape with rounded corners. However, it is understood that collar 103 could be a circular, oval or other shape to mate with the edge of any appropriately sized garbage can/recycle bin.

In an alternative embodiment, the housing of the scanner is shaped to mate nearly exactly with and partially fit inside the opening of the receptacle. In this embodiment, the scanner housing advantageously prevents the scanner from moving laterally within the opening of the receptacle. The collar, needing only prevent the scanner from dropping inside the receptacle, can use attachment flanges that simply rest atop the edge of the upper rim of the receptacle. This embodiment eliminates the need for the attachment flanges of the housing to flow over the edge of the upper rim of the receptacle. In yet a further alternative embodiment, collar 103 may be curved to adapt to garbage cans having openings that have various elevations or made to be adjustable so as to adapt to the size and shape of different sized garbage cans. For example, collar 103 may include telescoping sections capable of adjusting to larger or smaller garbage cans.

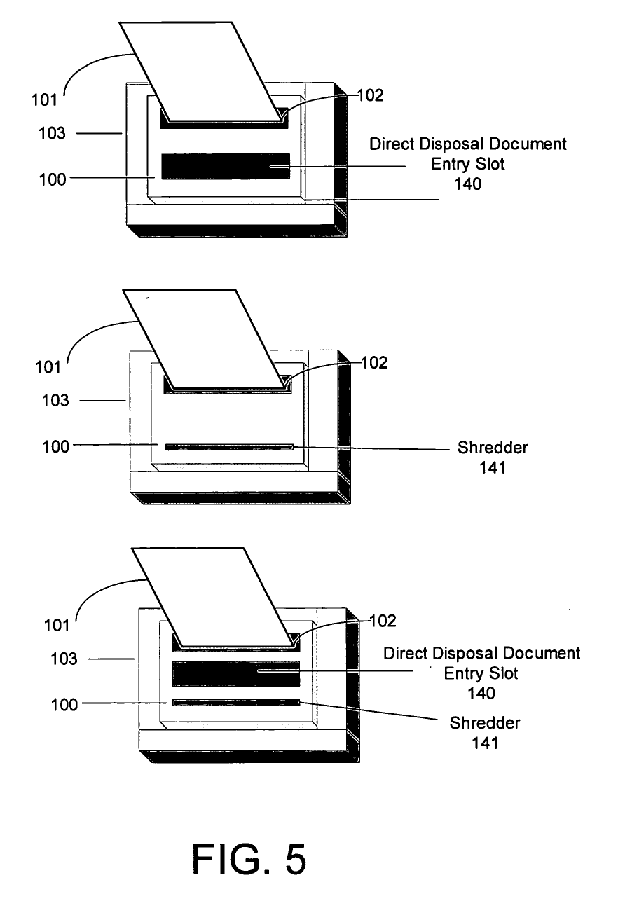

There are a number of possible configurations for collar 103 about the periphery of the scanner. According to a first configuration shown in FIG. 2, collar 103 circumscribes the entire periphery of scanner 100. In the first configuration, the user lifts the scanner 100 off the garbage can/recycle bin to throw refuse away without feeding it through the scanner. Alternatively, the garbage may include an additional opening below the top edge of the garbage can through which refuse may be deposited into the garbage can. The scanner or a portion of the collar may alternatively include a direct disposal document entry slot through which refuge may be deposited directly into the garbage can (element 140 of FIG. 5).

According to a second configuration shown in FIG. 2B, collar 103 circumscribes three sides of the periphery of scanner 100. In the second configuration, collar 103 positions the scanner 100 such that at least a portion of two edges and full third edge of the garbage is left exposed (preferably, one of the longer sides although any side of the receptacle may be left exposed). In addition, a substantial opening between the exposed edge of the receptacle and the front of scanner 100 is desirable. As a result, the user can both dispose of documents through the scanner, or the user can dispose of documents or other refuse directly into the garbage without having to remove the scanner. In this embodiment, refuse may be deposited into the garbage through the refuse opening. The second configuration also has the advantage of begin nearly as stabile as the first configuration. According to a third configuration, collar 103 is attached on opposing sides of scanner 100. Other configurations of the collar are within the scope of the present invention.

Scanner 100 remains atop the receptacle by way of the effect of gravity according to the above-described embodiments. However, it is understood that clips or other attachment means could be included with the collar 103 to allow the scanner to be fixedly attached to the garbage can.

It is anticipated that the user of the scanner 100 of the present invention will need to access the contents of the garbage can/recycle bin or holding cell 106 on numerous occasions. For example, when the garbage can/recycle bin is full and requires emptying, the user of the scanner will have to remove the scanner from the garbage can/recycle bin. Similarly, on those occasions in which the user wants a document scanned but not immediately disposed of as garbage or recycling material, the user will remove the scanner from the garbage can/recycle bin so the document can be retrieve from the receptacle or holding cell 106. To facilitate the removal of the scanner from the garbage can/recycle bin, handle 104 is affixed to the upper surface of the scanner 100. The user grabs handle 104 and lifts upwardly to remove the scanner from the garbage can/recycle bin. Handle 104 can also be a plurality of graspable indentations on the sides of the scanner or collars.

According to an alternative embodiment, scanner 100 includes a support mechanism to allow the user of the scanner 100 to lower the scanner to the floor and deposit it thereon without damaging the scanner. As shown in FIGS. 2 and 2A, one embodiment of the stand or support mechanism is a plurality of rubberized nuggets 107 disposed about the periphery of the bottom of the holding cell 106. In this manner, the user can lift the scanner 100 off of the receptacle by the handle and deposit the scanner and holding cell on the ground supported by rubberized nuggets 107 on the bottom of the holding cell 106. Alternatively, in embodiments in which do not include holding cell 106, the rubberized nuggets 107 can be disposed about the bottom of the scanner 100. Alternatively, scanner 100 can include a plurality of elongated protrusions on its bottom that serve as a stand for the scanner. These protrusions can support the scanner at any desired height above the ground, and may be adjustable with respect to how far off the ground the protrusions support the scanner.

Scanner 100 may be in communication with a host computer or other computing device including but not limited to a PDA or cellular telephone. The scanner scans documents and generates information representative of the characters/images appearing on the documents. The scanner transmits the information to the host computer or computer device. The host computer uses the information from the scanner to generate an electronic softcopy of the document. For example, a .pdf or .tiff image of the document can be created using appropriate software. The user can view the electronic document on his/her monitor. The user can store or file in an appropriate folder the electronic softcopy of the document in the host computer, computing device, portable memory or networked memory. The user can modify the document using appropriate software. The user can print another hardcopy of the original document or modified document using an attached or networked printer.

The information generated by the scanning element is transmitted to the computing device such as a host computer over the communication link 105. In configurations in which the scanner is maintained at a short distance from the host computer, the scanner includes a communication device capable of communicating information over a wired communication link such as USB 1.1, USB 2.0, Firewire or other wired communication protocol. For example, when the USB protocol is used, the scanner would include a USB controller as at least part of the communication device. In configurations in which the scanner is maintained at a greater distance from the host computer or in configurations in which the host computer has the capability to communicate wirelessly, for example using bluetooth, 802.11(a), (b) or (g) or some other wireless protocol, it is contemplated that the communication link 105 may be a wireless communication link. When a wireless communication link is employed, scanner 100 will include a wireless transmitter or transceiver to communicate with the host computer utilizing a wireless protocol. In the preferred embodiment, the transmitter or transceiver will be embedded within the scanner 100. The scanner 100 will communicate directly with the host computer using bluetooth or 802.11 in ad hoc mode. Alternatively, the scanner 100 may communicate indirectly with the host computer via a wireless access point (for example, using 802.11 in infrastructure mode) or other computer network. The communication between the scanner and host computer may alternatively be accomplished via hardwired cables.

As illustrated in FIG. 2A, a holding cell 106 is advantageously adapted to the bottom of the scanner 100. Holding cell 106 is designed to “catch” the documents as they exit the scanner before they are deposited in the garbage can/recycling bin. As mentioned earlier, it is anticipated that the user of the present invention will have occasion to retrieve documents before they are deposited in the garbage or for recycling. The holding cell 106 allows the user to retrieve scanned documents before they are so deposited. As shown, the holding cell 106 is manufactured using wire mesh. It can manufacture out of any appropriate material, such as plastic. It is preferable that the holding cell is transparent to allow the use to view any documents held in the holding cell 106.

Holding cell 106 includes a document door 108. After the documents are scanned, they drop into the holding cell 106. A user can retrieve the documents by opening the document door 108. When to user has determined that he/she no longer has any need for the document retrieved from the holding cell 106 through the document door 108, the user can deposit the documents into the trash by removing the scanner from the can/bin via lifting the scanner by the handle. Alternatively, in those configurations in which a gap is maintained between scanner and the edge of the cab/bin, the documents can be directly deposited in the can/bin without removing the scanner.

Holding cell 106 may also include a spring-loaded trap door 109 and release mechanism 110. In those instances in which the user has no need to retrieve scanned documents from the holding cell but instead decides to release them for disposal, the user can activate the release mechanism 110. The release mechanism 110 causes the spring-loaded trap door 109 to open. Any documents held in the holding cell when the trap door 109 is opened fall by gravity into the can/bin. After the documents are released into the can/bin via the spring-load trap door, the door will return to a closed position to accommodate additional scanned documents.

As illustrated in FIG. 2A, the scanner of the present invention has a very small footprint. Thus, it is contemplated that a user may elect to use the scanner of the present invention as a standalone unit. When used as a standalone unit, the scanner 100 preferably omits the collar 103 and stand 120 (discussed immediately below). Scanner 100 as a standalone unit may still include among other things handle 104.

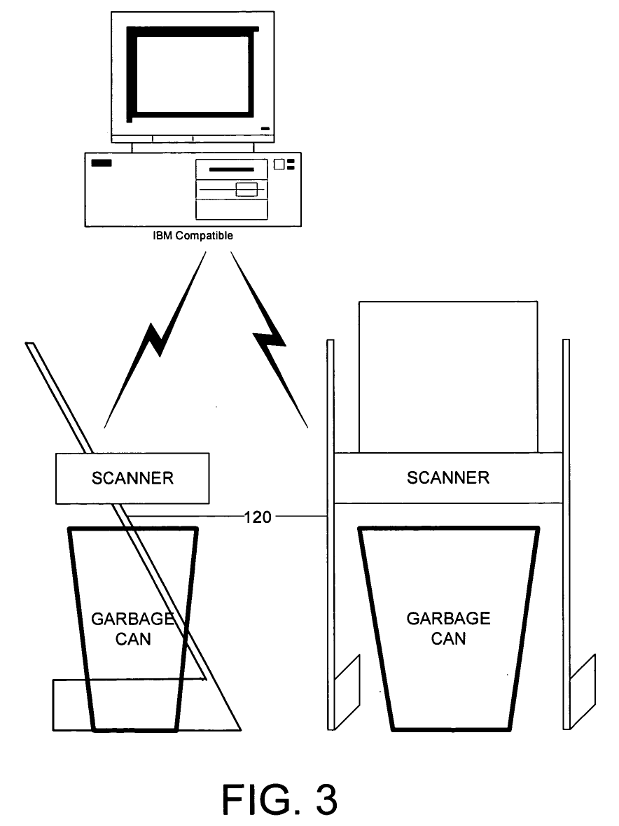

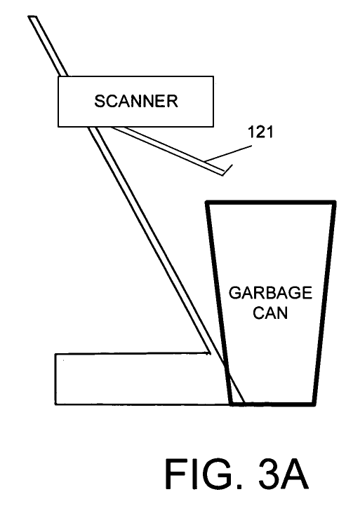

FIGS. 3 and 3A illustrate alternative embodiments of the present invention. In FIG. 3, stand 120 replaces collar 103 to support scanner 100 directly over the receptacle. Stand 120 may be a skeletal structure as illustrated in the figures or may be a solid structure encapsulating all or part of the scanner and receptacle. Preferably, stand 103 connects to the periphery of scanner to avoid interference with document egress slot. This configuration allows the holding cell to be maintained under the scanner without interference from the stand. Stand 103 may alternatively include a platform on which scanner 100 sits atop. The platform includes an appropriate opening to accept the document to pass out of the document egress slot and into the receptacle and/or the holding cell. Stand 103 may be manufactured and sold separately from scanner 100. The embodiment incorporating stand 120 offers a couple of advantages over the collar 103 embodiment. When the stand rather than the collar supports the scanner, the garbage can remains relatively accessible to the user in the normal manner. The user may remove the garbage can/recycle bin for emptying or other uses without disturbing the scanner. The stand may be manufactured in a variety of configurations and from a variety of materials. FIG. 3A illustrates an embodiment of the present invention where the stand 120 supports scanner 100 slightly away from directly over the receptacle. A catch tray 121 is included. Catch tray 121 performs a similar function to holding cell 106. After the scanner 100 scans documents, they exit the document egress slot and are caught on the catch tray 121. The user can retrieve the scanned documents from the catch tray 121 before they are deposited into the receptacle. A trap door and release mechanism similar to those discussed in connection with the holding cell may be incorporated in the catch tray 121.

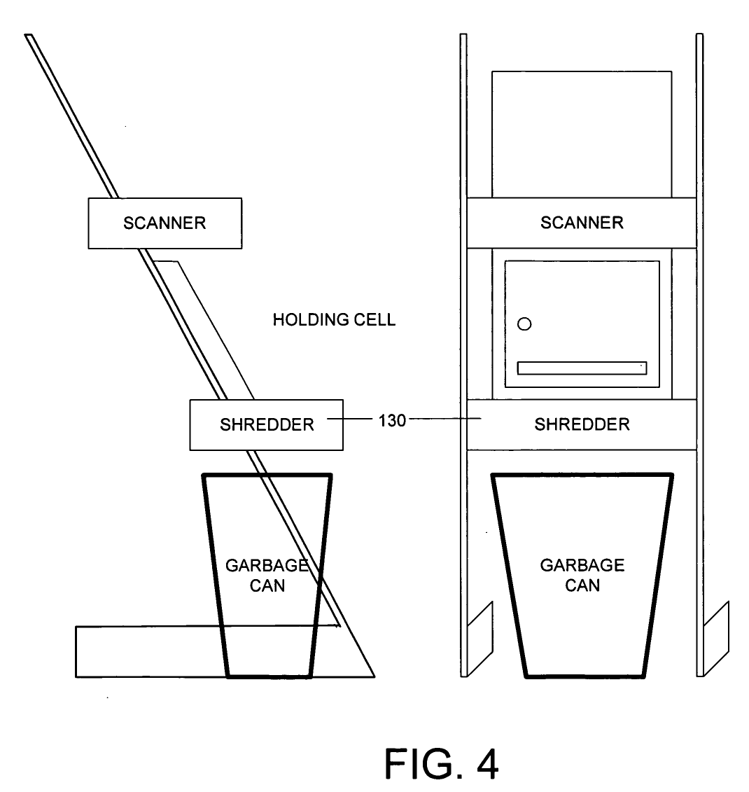

FIG. 4 illustrates a scanner/shredder combination according to a further alternative embodiment of the present invention. Similar to the embodiment illustrated in FIG. 3A, scanner 100 is supported on a stand 120. Scanned documents exit the scanner 100 and are caught by a holding cell/catch tray. The user can retrieve the scanned documents from the holding cell/catch tray. When the user has determined that he/she no longer needs the documents, the user activates the release mechanism. The release mechanism temporarily releases the trap door thereby releasing the documents. A shoot to the entry slot for the shredder 130 directs the documents. The shredder 130 automatically activates and shreds the documents. The combination of scanning and shredding documents has the advantage of increasing the security of the office place. Hardcopies of the documents are forever destroyed.

FIG. 5 illustrates the top views of various scanner and shredder configurations in accordance with alternative embodiments of the invention. In the top illustration, the top of the scanner or collar includes a direct disposal document entry slot 140 through which refuge may be deposited directly into the garbage can. In the middle illustration, a housing is shown which incorporates both a shredder 141 and a scanner. In the bottom illustration, a housing is shown which incorporates a shredder 141, scanner and direct disposal document entry slot 140. In embodiment of present invention in which a user may mistake a shredder entry point for a scanning entry point such as those shown on FIG. 5, a security measure is incorporated which is designed to prevent the user from shredding a document when he/she intends to be scanning the document. Such measures may include requiring the user to confirm his choice by pressing a button, throwing a switch or a loud beep.

As described above, embodiments of the invention contemplate a stand-alone scanner with an affixed collar 103 or stand 120. The present invention also contemplates that the collar 103 or stand 120 is removable from the scanner 100. A stand-alone scanner utilizing document or sheet feeder technology can be reasonably small and light—in fact, small enough to fit in one's travel attache. A user of the scanner of the present invention can advantageously convert the scanner of the present invention into a portable scanner and take the scanner with him/her on a business trip by removing the collar or stand. When the user reaches their destination or returns from the trip, he/she reaffixes the collar 103 or stand 120 and replaces it atop the receptacle. Further, in embodiments where a smaller, lighter scanner is used, a tray with a cut-out adapted to mate with the footprint of the scanner can be used instead of a collar or stand. The tray includes attachment flanges on two or more sides to attach to the receptacle. In a manner similar to the removable collar or stand, the scanner can be removed from the tray and transported with the business traveler.

The scanner and scanning element are understood to encompass known scanning apparatus and methods capable of reading the information on each page of the document and converting the image to an analog or digital form, such as a flat bed or line scanner. It is also within the ambit of the present invention to utilize a scanner incorporating other functionality into scanner 100 such as one or more of phone, fax and copying capability. The scanner 100 can also include a LCD screen. The LCD screen allows the user to review what has been scanned and determine whether a document has been scanner properly. According to this embodiment, prior to the document feeder releasing the document and depositing it in the holding cell or receptacle, the user is queried whether the document has been properly scanned via audio and visual prompt. If the user responds in the negative, the document feeder makes a second pass of the document in front of the scanning element and repeats the query process. Alternatively, the progress and monitoring of a scan may be illustrated over the host computer via the communication modes described above.

In the above-described embodiments, the scanner, document holders (holding cells and trays) and/or shredder are stationarily supported over a garbage can or recycling receptacle. In an alternative embodiment, one or more of the scanner, document holders and shredder may be supported on either the garbage can or support stand, and capable of movement between a first position, where the scanner, document holder and/or shredder are positioned over the garbage can/recycling receptacle, and a second position, where the scanner, document holder and/or shredder are not positioned over the garbage can/recycling receptacle. Support mechanisms are known which are capable of allowing free sliding or translating of the scanner, document holder and/or shredder between the first and second positions. Support mechanisms are also known which are capable of allowing free pivoting of the scanner, document holder and/or shredder between the first and second positions.

In a further embodiment of the present invention, some or all of the components described above, including the scanner, document holders, shredder and/or garbage or recycling receptacle may be enclosed within a cabinet having one or more openings for receiving documents to be scanned and refuse. In this embodiment, as well as the embodiments described above, the garbage can may be an off-the-shelf garbage can (i.e., not customized to work with the scanner, document holder and/or shredder). Alternatively, the garbage can may be customized to operate with the scanner, document holder and/or shredder described above.

Although this invention has been disclosed in the context of certain preferred embodiments and examples, it will be understood by those skilled in the art that the present invention extends beyond the specifically-disclosed embodiments to other alternative embodiments and/or uses of the invention and obvious modifications and equivalents thereof. In addition, while a number of variations have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed apparatus. Thus, it is intended that the scope of the present invention should not be limited by the particular disclosed embodiments described above, but should be determined only by a fair reading of the claims that follow.

What is claimed is:

1. A scanning apparatus comprising:
a scanner having a housing, the housing having
a document entry slot, and
a document egress slot,
and enclosing
a document handling mechanism, and
a scanning element for scanning the information on a document and converting the information to an analog or digital form;
a communication device for communicating the converted information about a scanned document to a host computer over a communication link for the purpose of generating of an electronic version of the scanned document on the host computer which can be subsequently viewed or stored on the host computer; and
a collar for supporting the scanner at the opening of a garbage or recycling receptacle having an upper rim, the collar resting upon the upper rim of the garbage or recycling receptacle such that the scanner is supported at the opening of the garbage or recycling receptacle and can be removed therefrom,
wherein the document handling mechanism is designed to take a document entered via the document entry slot, pass it to be scanned by the scanner element, feed it through the document egress slot, and release it in the direction of the garbage or recycling receptacle.

2. The scanner of claim 1, further comprising a catching structure to catch documents released by the document handling mechanism in the direction of the garbage or recycling receptacle before they are deposited in the garbage or recycling receptacle.

3. The scanner of claim 2, wherein the catching structure further comprises a door which can be opened to release documents caught in the catching structure into the garbage or recycling receptacle.

4. The scanner of claim 1, wherein the scanner and the support element are configured in such a way that a user can deposit documents directly into the opening of the garbage or recycling receptacle without feeding them into the scanner.

5. The scanner of claim 1, wherein the communication link between the scanner and host computer is a wired link using the USB protocol.

6. The scanner of claim 1, wherein the communication link between the scanner and host computer is a wireless link.

7. The scanner of claim 1, wherein the housing encloses a document shredder such that the user can choose between scanning the document and shredding the document.

8. A scanning apparatus comprising:
a scanner having a housing, the housing having
a document entry slot, and
a document egress slot,
and enclosing
a document handling mechanism, and
a scanning element for scanning the information on a document and converting the information to an analog or digital form;
a communication device for communicating the converted information about a scanned document to a host computer over a communication link for the purpose of generating of an electronic version of the scanned document on the host computer which can be subsequently viewed or stored on the host computer; and
a support stand supporting the scanner at the opening of a garbage or recycling receptacle having an upper rim,
wherein the document handling mechanism is designed to take a document entered via the document entry slot, pass it to be scanned by the scanner element, feed it through the document egress slot, and release it in the direction of the garbage or recycling receptacle.

9. The scanner of claim 8, further comprising a catching structure to catch documents released by the document handling mechanism in the direction of the garbage or recycling receptacle before they are deposited in the garbage or recycling receptacle.

10. The scanner of claim 9, wherein the catching structure further comprises a door which can be opened to release documents caught in the catching structure into the garbage or recycling receptacle.

11. The scanner of claim 8, wherein the scanner and the support element are configured in such a way that a user can deposit documents directly into the opening of the garbage or recycling receptacle without feeding them into the scanner.

12. The scanner of claim 8, wherein the communication link between the scanner and host computer is a wired link using the USB protocol.

13. The scanner of claim 8, wherein the communication link between the scanner and host computer is a wireless link.

14. The scanner of claim 8, wherein the housing encloses a document shredder such that the user can choose between scanning the document and shredding the document.

15. A scanning/shredder apparatus comprising:
a scanner having
a document entry slot, and
a document egress slot,
a document handling mechanism,
a scanning element for scanning the information on a document and converting the information to an analog or digital form, and
a communication device for communicating the converted information about a scanned document to a host computer over a communication link for the purpose of generating of an electronic version of the scanned document on the host computer which can be subsequently viewed or stored on the host computer;
a shredder; and
a support stand supporting the scanner such that the output of the scanner is feed into the shredder and supporting the shredder above the opening of a garbage or recycling receptacle having an upper rim,
wherein the document handling mechanism is designed to take a document entered via the document entry slot, pass it to be scanned by the scanner element, feed it through the document egress slot, and release it in the direction of the shredder which shreds the document before it is deposited in the garbage or recycling receptacle.

16. The scanner/shredder of claim 15, further comprising a catching structure to catch documents released by the document handling mechanism in the direction of the shredder before they are shredded.

17. The scanner/shredder of claim 16, wherein the catching structure further comprises a door which can be opened to release documents caught in the catching structure to the shredder.

18. The scanner/shredder of claim 17, further comprising a button designed to open the door upon actuation.

19. The scanner/shredder of claim 15, wherein the communication link between the scanner and host computer is a wired link using the USB protocol.

20. The scanner/shredder of claim 15, wherein the communication link between the scanner and host computer is a wireless link.
